(19) United States
(12) Patent Application Publication
(10) Pub. No.: US 2018/0167678 A1
(43) Pub. Date: Jun. 14, 2018

(54) INTERACTIVE MEDIA SYSTEM

(71) Applicant: EchoStar Technologies L.L.C., Englewood, CO (US)

(72) Inventors: Rob Johannes Clerx, Boulder, CO (US); Nicholas Brandon Newell, Centennial, CO (US)

(73) Assignee: EchoStar Technologies L.L.C.

(21) Appl. No.: 15/378,950

(22) Filed: Dec. 14, 2016

(51) Int. Cl. H04N 21/442; H04N 21/45; H04N 21/454; H04N 21/466; H04N 21/475

(52) U.S. Cl. CPC H04N 21/44218; H04N 21/4532; H04N 21/454; H04N 21/4758; H04N 21/44222; H04N 21/4662; H04N 21/4667

(57) ABSTRACT

A computer that includes a processor and memory, wherein the memory stores instructions executable by the processor, wherein the processor is programmed to: predict a first score for a first user who has not viewed a media unit based on at least an affinity score between the first user and a second user and rating data provided by the second user that is associated with the media unit; after the first user has viewed the media unit, determine a second score for the first user based on rating data provided by the first user that is associated with the media unit; and upon determining that a difference between the first score and the second score is greater than a threshold, initiate a digital dialogue between the first and second users.

### BACKGROUND

In conventional media rating systems, a viewer attempts to express complex emotions and thoughts using a numerical rating system (e.g., one to five stars) weeks or months after viewing a television show or movie. Moreover, the viewer's rating occurs in isolation—i.e., without input or participation of viewers in other households. Using such a procedure, many aspects of the show or movie are not rated or considered, and hence the rating may be inaccurate. Such rating systems do not engage their viewers because they do not have the technology to connect their viewers in a manner which can improve the accuracy of the system. Thus, there is a need to provide such a media system.

### BRIEF DESCRIPTION OF THE DRAWINGS

FIG. 1 is an exemplary schematic diagram of an interactive media system.

FIG. 2 a flow diagram illustrating an example method of initiating a digital dialogue regarding media content between users of the interactive media system shown in FIG. 1.

FIG. 3 is a schematic diagram illustrating example user data.

FIG. 4 is a flow diagram illustrating a portion of the method shown in FIG. 2.

### DETAILED DESCRIPTION

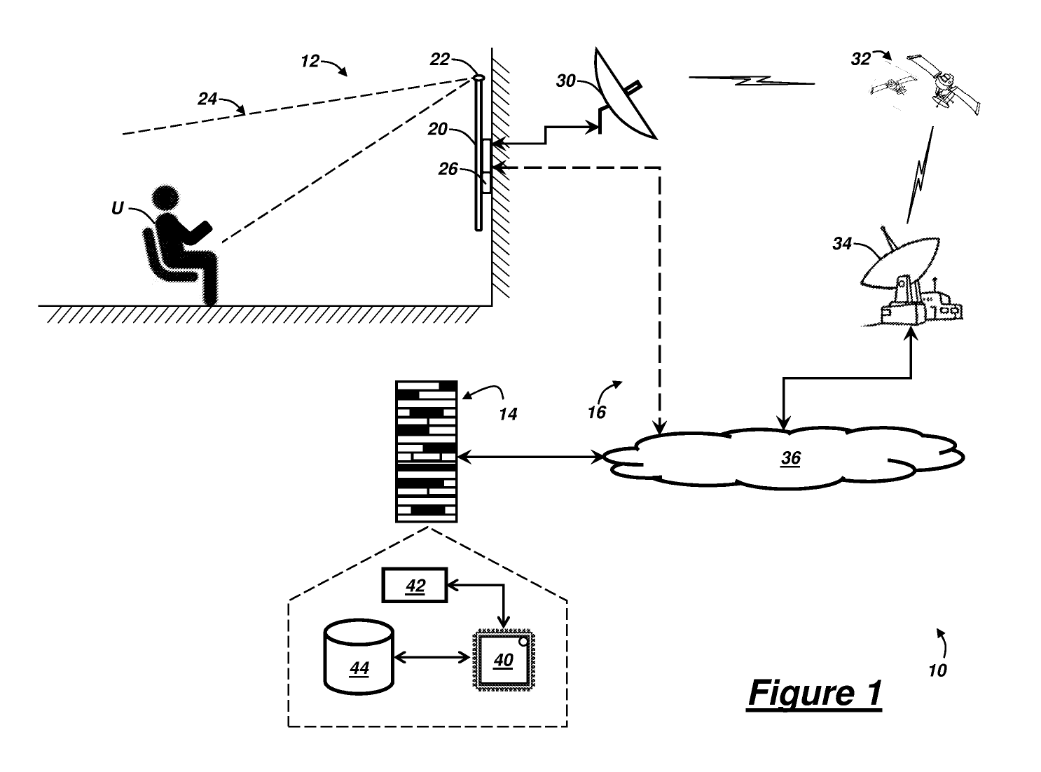

Described herein is an interactive media system 10 (FIG. 1) capable of improving the experience of viewers who watch media content such as movies, television, etc. As discussed in detail below, the media system 10 includes a user entertainment system 12 and a computer 14 configured to: determine a viewer's predicted rating for a media unit before the viewer watches the content (of the media unit) based on past viewing preferences and affinities with other viewers; determine an actual rating based on a viewer's response(s) following the viewer watching the content; and when the predicted and actual ratings differ more than a threshold amount, engage the viewer with at least one other viewer via a digital dialogue to encourage a discussion of their differing opinions and observations. In addition, data extracted from the resulting dialogue may be used to update affinity data and to improve future predicted ratings for these and other viewers.

In general, computer 14 may act as a media content provider or distributor that provides media content via one or more media units. Media content includes any suitable audio, visual, and/or tactile information transmitted by the computer for viewing by a user or subscriber audience (e.g., via entertainment systems 12 described below). Viewing, as used herein, can include just listening, just watching, just feeling or sensing using touch, or any combination thereof.

A media unit, as described more below, is a compilation of digital media content information having a predetermined duration that is transmitted from computer 14 to a number of different entertainment systems 12. For example, digital media units can be generally delivered via communication system 16 in a digital format, e.g., as compressed audio and/or video data. The digital media units can include, according to a digital format, media data and content metadata. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, a media unit may be provided in a format such as the MPEG-2 transport stream (TS) format, sometimes also referred to as MTS or MPEG-TS, or the H.264/MPEG-4 Advanced Video Coding standards (AVC) (H.264 and MPEG-4 at present being consistent), or according to some other standard or standards. For example, a media unit 102 could be audio data formatted according to standards such as MPEG-2 Audio Layer III (MP3), Advanced Audio Coding (AAC), etc. Further, the foregoing standards generally provide for including metadata, e.g. content metadata, along with media data, in a file that includes a media unit, such as the content metadata discussed herein.

Thus, each media unit may include media content as it is usually provided for general distribution, e.g., a movie, a movie or film clip, television program (e.g., a television episode, a season of television episodes, a television mini-series, a television series comprising one or more television seasons, a documentary, etc.), an advertisement or solicitation, video file, audio file, etc. in a form has provided by a media content provider of the media unit. Alternatively or additionally, media content and/or media units may be modified from the form provided by a general media content provider (e.g., recompressed, re-encoded, etc.). The media data includes data by which a display, playback, representation, etc. of the media units is presented via entertainment systems (e.g., such as system 12). For example, the media units may include collections or units of encoded and/or compressed video data, e.g., frames of an MPEG file or stream.

Content metadata may include metadata as provided by an encoding standard such as an MPEG standard. Alternatively and/or additionally, content metadata could be stored and/or provided separately to entertainment system 12, apart from media data. In general, content metadata provides an index by which locations in the media data may be identified, e.g., to support rewinding, fast forwarding, searching, pausing, resuming, etc. Metadata may also include general descriptive information for an item of media content. Examples of content metadata include information such as content title, chapter, actor information, Motion Picture Association of America MPAA rating information, reviews, and other information that describes an item of media content.

In general, computer 14 may receive rating data from users (e.g., viewers or subscribers) regarding the media units. The rating data may have quantitative characteristics and/or qualitative characteristics (e.g., it may comprise quantitative data and/or raw qualitative data). Quantitative data includes digital information that includes at least one numerical value indicating whether a user enjoyed or disliked at least one aspect of a media unit. As described more below, quantitative data may include, e.g., a digital entry by a user representing a number or a quantity on a scale, human speech or spoken words from the user that include a numerical value, and/or human speech or spoken words from the user that include a quantity indicating the user's rating of at least a portion of a media unit, an attribute or characteristic of the media unit, or an attribute or characteristic associated with the media unit.

Raw or unprocessed qualitative data includes digital information absent numerical values indicating whether a user enjoyed or disliked at least one aspect of the media unit. As described more below, qualitative data may include, e.g., a word, a phrase or sentence, a facial expression, a bodily gesture, a vocal inflection, a vocal pattern, or the like that indicates whether the user enjoyed or disliked at least one aspect of the media unit. Thus, as also described more below, qualitative data may include or be derived from human speech (or spoken words) or human actions that pertaining to a user's judgment of a quality or value of some aspect of the media unit.

Turning now to FIG. 1, the system 10 includes a plurality of entertainment systems 12 (for ease of illustration, only one is shown as an example) coupled to a computer or remotely located server 14 via a communication system 16. Entertainment systems 12 may be located in a customer premises, such as a residence, a place of business, or the like and may include one or more televisions 20 connected to communication system 16. As used herein, the term television should be construed broadly to include any suitable television unit (flat screen television, CRT television, etc.), any suitable digital media display, a computer screen, a computer monitor, or the like). The television 20 may be coupled electronically to a recording device 22 oriented so that a corresponding field of view 24 can image or capture at least one viewer or user U. The recording device 22 may be a so-called webcam, a so-called camcorder, or any other suitable imaging device (e.g., including but not limited to charge-coupled devices (CCDs) and complementary metal-oxide-semiconductor or CMOS devices). The recording device 22 may convert analog data into digital data; it may be adapted to store this digital data in memory therein, and/or it may be adapted to stream the digital data as a source device to computer 14 via communication system 16.

Entertainment system 12 also may include a media device 26 coupled between the television 20 and the communication system 16 and configured to receive and display media content received in the form of a media unit. In some implementations, device 26 also can send or transmit information to computer 14 via communication system 16. Non-limiting examples of media device 26 include a so-called set-top box, a laptop, desktop computer, tablet computer, game box or console, etc., any of which may be configured to download and/or store media content (e.g., on demand, according to a pre-program schedule, etc.). As used herein, media content refers to digital audio data or information and/or digital video data or information received from computer 14 via media device 26 for display on television 20. And as used herein, a media file or media unit is a compilation of digital media content (digital media data) having a predetermined duration; non-limiting examples of media units include: a movie or film, a movie or film clip, a television episode, a season of television episodes, a television mini-series, a television series comprising one or more television seasons, a documentary, and an advertisement or solicitation, just to name a few examples.

Viewer or user U may be any suitable person or user who receives media content ultimately from computer 14 or from a computing device or server associated with computer 14 (e.g., owned and/or operated by the same operating entity). In at least some implementations, user U is a subscriber—e.g., having an identifiable account associated with computer 14. In other instances, user U may be any person viewing a subscriber's account (e.g., an invitee or other authorized user of user U's account—e.g., in user U's home or business).

Communication system 16 may be any combination of wired and/or wireless links or connections establishing one or more one-way and/or two-way communication paths between computer 14 and entertainment system 12. According to one example, at least a portion of system 16 is a wireless communication link using a satellite transceiver 30 (coupled to media device 26 of entertainment system 12), a constellation of one or more satellites 32, and a satellite transceiver 34. In at least one example, transceiver 34 is a so-called satellite uplink and transceiver 30 is a so-called satellite downlink—wherein media content is broadcast from the satellite uplink 34 to the satellite downlink 34 via at least one of the satellites 32—e.g., using communication techniques known to those skilled in the art. In the illustrated example, the satellite uplink 34 is coupled to computer 14 via a land communication network 36. Network 36 may include any wired network enabling connectivity to public switched telephone network (PSTN) such as that used to provide hardwired telephony, packet-switched data communications, internet infrastructure, and the like. Network 36 is generally known in the art and will not be described further herein. Of course, this is merely one example; other examples of communication systems exist.

For example, the communication system 16 may include a wired connection between entertainment system 12 and computer 14 (e.g., via a land communication network 36). This network 36 may be used to deliver media content to entertainment system 12 from computer 14 or, as will be explained more below, deliver interaction data and feedback data from users (U) to computer 14. In at least one implementation, the entertainment system 12 and computer 14 communicate at least partially via the land communication network 36—e.g., user U may engage in discussion or digital dialogue with other users in other households, other businesses, etc. via land communication network 36, as explained more below.

Communication system 16 can utilize various other communication techniques in addition to or in lieu of those described above. For example, system 16 may include any other suitable wireless communication techniques, including but not limited to, cellular communication via cellular infrastructure configured for LTE, GSM, CDMA, etc. communication.

Computer 14 is illustrated as a server computer that is specially-configured to: based on past preferences and affinities of other users, predict a user's rating or score for a media unit before the user U watches the media unit (e.g., via television 20); determine a calculated or actual rating or score based on a user's response following user U watching the media unit; and when the predicted and actual ratings differ more than a threshold amount, engage user U with at least one other user to encourage a discussion of their differing opinions and observations. While a single server is illustrated, it should be appreciated that computer 14 may be representative of multiple servers which may be interconnected and configured to operate together. Further, computer examples other than a server are also contemplated herein.

Computer 14 may include one or more processors 40, memory 42, and one or more databases 44. Processor(s) 40 can be any type of device capable of processing electronic instructions, non-limiting examples including a microprocessor, a microcontroller or controller, an application specific integrated circuit (ASIC), etc.—just to name a few. Processor 40 may be dedicated to server 14, or it may be shared with other server systems and/or computer subsystems. As will be apparent from the description which follows, computer 14 may be programmed to carry out at least a portion of the method described herein. For example, processor(s) 40 can be configured to execute digitally-stored instructions which may be stored in memory 42 which improve the experience of users (such as user U) when watching media content such as movies, television, etc.

Memory 42 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 42 may store one or more computer program products which may be embodied as software, firmware, or the like.

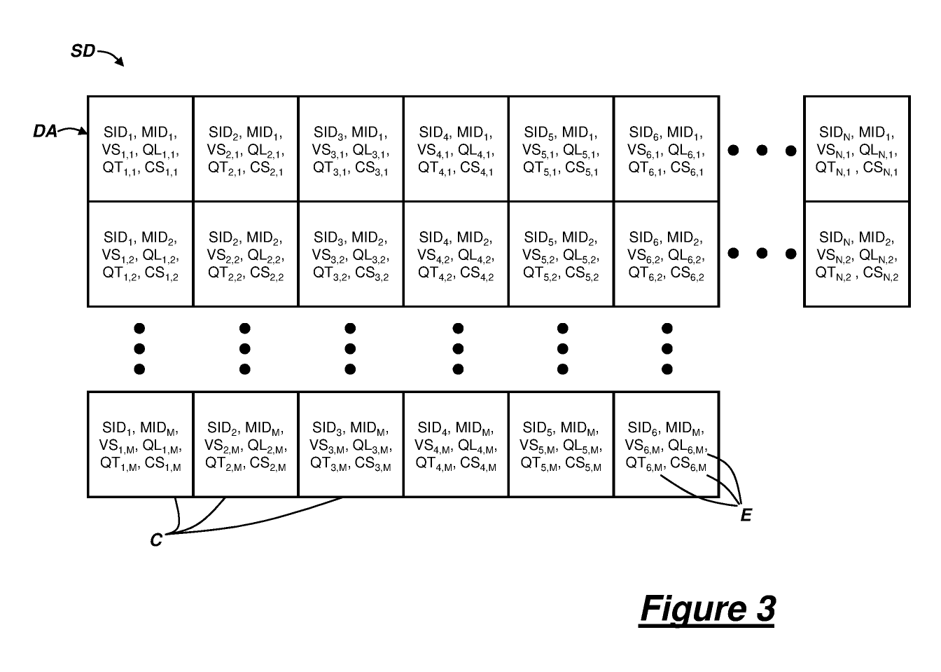

In at least one example, computer 14 includes one or more databases 44 to store, among other things, collections of media content in a filing system. For example, one or more databases 44 may be dedicated to storing movies, television series (e.g., organized by episode, season, series, etc.), documentaries, television specials, etc. A portion of the databases 44 may be used to store subscriber or user data SD such as that shown in FIG. 3, which will be described in greater detail below. Files in the databases 44 may be called upon by computer processor 40 and used to carry out at least a portion of the method described herein.

Computer 14 may be configured to execute one or more automatic speech recognition (ASR) algorithms, one or more vocal inflection recognition algorithms, one or more vocal pattern recognition algorithms, one or more facial recognition (or facial biometric recognition) algorithms, one or more gesture recognition algorithms, and the like. Using one or more of these algorithms, video files received from users may be analyzed to determine qualitative data and/or quantitative data associated with their opinions, preferences, etc. associated with a particular media unit, as described more below. For example, using a video file of user U, the computer 14 may be configured to parse the video file and identify key words, key phrases, vocal inflections, vocal patterns, facial expressions, body language or gestures, etc. which can assist the computer 14 in determining whether the user U liked one or more aspects of the particular media unit (and to what degree). Algorithms for speech recognition, vocal inflection recognition, vocal pattern recognition, facial recognition, gesture recognition, etc. (and the techniques for using them) are known and will not be described in greater detail herein.

### Method

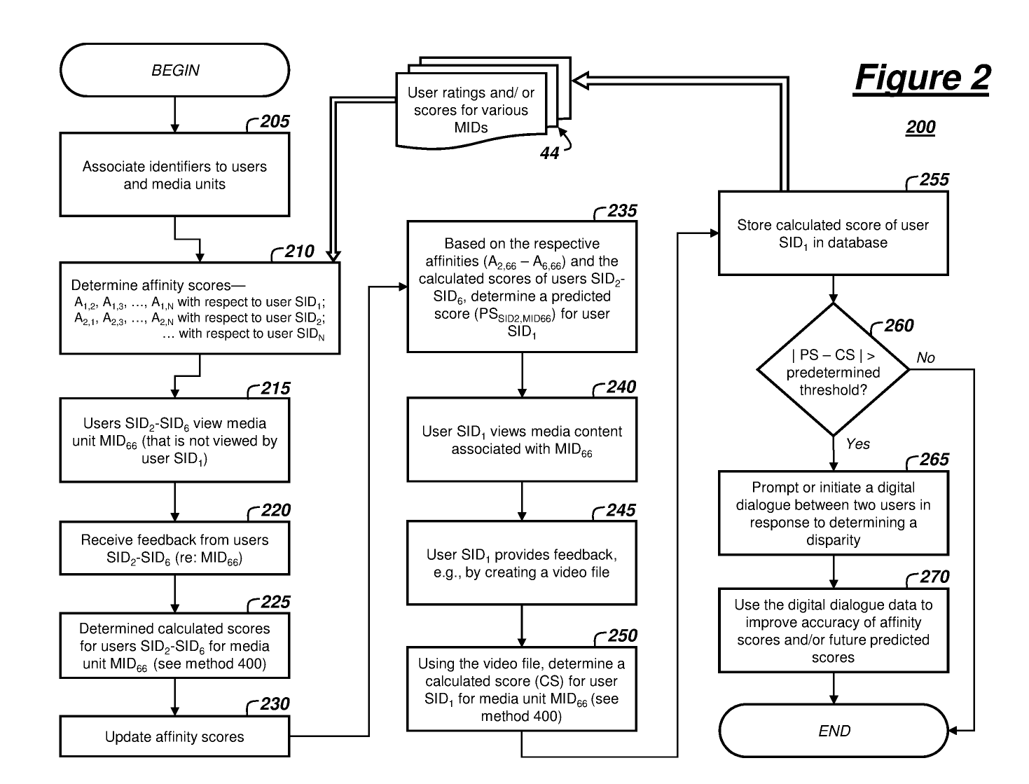

FIG. 2 illustrates a method 200 of using interactive media system 10 to improve the media viewing experience of users, such as user U. The method may begin with step 205 wherein the computer 14 assigns or associates a unique identifier to each user or subscriber account (a SID) (e.g., users belonging to a so-called subscriber or user community) and assigns or associates a unique identifier to each media unit (a MID) stored in databases 44. Non-limiting examples of SIDs and MIDs include a unique numerical identifier, a unique alpha-numerical identifier, a unique email address, etc. The quantity of users which subscribe to services provided by media system 10 may be relatively large (e.g., hundreds of thousands, millions, billions, etc.). Similarly, the quantity of media units can be relatively large as well (hundreds to billions or more). As will become apparent from the description below, by assigning identifiers (SID, MID, etc.) to users and media units, the computer 14 may determine which users have viewed which media units.

FIG. 3 illustrates user or subscriber data SD that may be used by processor 40 to carry out at least a portion of the method 200; in some implementations, the user data is stored in memory 42 and/or databases 44. For illustrative purposes, the user data is arranged as a data array DA; however, this is merely an example (e.g., other data types also could be used). Data array DA may include multiple sub-arrays, sub-structures, etc. denoted here as cells C, wherein each cell C contains multiple data elements E. While not shown in FIG. 3, each cell C could also have an identifier in some implementations. Non-limiting examples of data elements include a unique subscriber identifier (a SID), a unique media unit identifier (a MID), a viewing status (VS) indicating whether the respective user (SID) has viewed the particular media unit (MID), a set of qualitative data (QL) indicating qualitatively whether the user enjoyed or disliked the content or aspects of the content of the respective media unit, a set of quantitative data (QT) indicating quantitatively whether the user enjoyed or disliked the content or aspects of the content of the respective media unit, and an actual or calculated score (CS) that includes a numerical representation of the particular user's liking, fondness, admiration, partiality, or attraction to the media unit designated in the respective cell (e.g., a high calculated score may indicate that the user liked the content of the media unit, whereas a low calculated score may indicate the user disliked the content). As will be described below, the calculated score (CS) may be derived from quantitative data, qualitative data, or a combination thereof and, in some instances, may be a weighted value. Cells C could include other data elements as well; these are merely examples.

The cells may be created or generated by computer 14 (e.g., to accommodate the number of users and/or media units). For example, each user (SID) and each available media unit (MID) can be represented in the data array DA—wherein, the quantity (N) of users and the quantity (M) of media units may be any suitable quantities. In another example, the data array DA may comprise a subset or selected quantity M of media units (MIDs); e.g., only those media units for which the computer 14 desires feedback or interactivity, as explained more below. Alternatively, or in addition thereto, in some examples, the data array DA may comprise a subset or selected quantity N of users (SIDs).

Initial values may be assigned to at least some of the data elements E. For example, in each cell C, data elements VS, QL, QT, and CS initially may be assigned a zero (‘0’) value indicating null or not determined.

In step 210, closeness or affinity scores (A) are determined between at least some of the users—e.g., between SID₁ and each of SID₂, SID₃, . . . , SID_{N}, between SID₂ and each of SID₃, SID₄, . . . , SID_{N}, . . . , etc. Any suitable quantity of affinity scores may be determined between any suitable users. In general, an affinity score can be a value based on common, related, or similar characteristics between users—e.g., close or closer media viewing habits, close or closer liked or desired media content, close or closer media viewing relationships or associations, any other characteristic that suggests a close or closer relationship between the feelings or emotions of the respective users, or any combination thereof. More particularly, affinity scores (A) between two users may be determined by computer 14 using any predetermined set of criteria—including but not limited to familial relationship, friend relationship, a so-called media ‘friend-like’ relationship which includes a social media type connection linking two users to one another based upon an explicit and so-called ‘friend-like request,’ a quantity and content of previous online or digital dialogues between users, related or associated qualitative data (QL) received from the respective users, related or associated quantitative data (QT) received from the respective users, a physical proximity or location of the respective users. FIG. 2 illustrates that the previous determined and/or stored ratings and/or scores (from database 44) also may be used to determine affinities in step 210. In addition, these and other criteria may be weighted so that computer 14 may determine a respective affinity score between two users—e.g., an affinity score between SID₁ and SID₂ is shown as A_{1,2}, an affinity score between SID₂ and SID₃ is shown as A_{2,3}, etc.—higher affinity scores (A) may suggest that the two users may enjoy the content of at least some of the same or similar media units.

One non-limiting example of calculating an affinity score accounts for: an explicit input AI_{EXPLICIT} (e.g., having an explicit priority value AP_{EXPLICIT} (e.g., AP_{EXPLICIT}=5)), a dialogue input AI_{DIALOGUE} (e.g., having a dialogue priority value AP_{DIALOGUE} (e.g., AP_{DIALOGUE}=4)), an expertise input AI_{EXPERTISE} (e.g., having an expertise priority value AP_{EXPERTISE} (e.g., AP_{EXPERTISE}=3)), a content input AI_{CONTENT} (e.g., having a content priority value AP_{CONTENT} (e.g., AP_{CONTENT}=2)), and a location input AI_{LOCATION} (e.g., having a location priority value AP_{LOCATION} (e.g., AP_{LOCATION}=1)). Using these exemplary inputs and priority values, an affinity score (expressed as a percentage) may be calculated according to the equation below. The priority values used in the equation below may be predetermined values and may be stored in memory 42 and/or databases 44.

In one example, affinity score A=(AI_{EXPLICIT}*AP_{EXPLICIT}+AI_{DIALOGUE}*AP_{DIALOGUE}+AI_{EXPERTISE}*AP_{EXPERTISE}+AI_{CONTENT}*AP_{CONTENT}+AI_{LOCATION}*AP_{LOCATION})/(10*(AP_{EXPLICIT}+AP_{DIALOGUE}+AP_{EXPERTISE}+AP_{CONTENT}+AP_{LOCATION}))*100. Of course, the priority values described above are merely examples; in other examples, other values may be used. Further, the inputs may be used in any combination. And additional or fewer inputs could be used in other examples.

The inputs may be provided or determined with respect to a respective user pair. For example, an explicit input AI_{EXPLICIT} can include a first user (in the pair) selecting the other user (in the pair) with whom he/she deems to have some personal or like affinity. The selection may count as an explicit point and may have a multiplier. For example, if the user selects the other user as an acquaintance, the multiplier may be 1×; and if the user selects the other user as a colleague, the multiplier may be 2×; and if the user selects the other user as a good friend, the multiplier may be 3×; and finally, if the user selects the other user as a best friend forever (a BFF), the multiplier may be 4×. In this example, four scaled categories were used as exampleseach having a progressively higher level of affinity (e.g., acquaintance, colleague, good friend, BFF); however, these are merely examples of categorical levels, and other examples exist.

Dialogue input AI_{DIALOGUE} can be based upon user-interaction via media device 26 (e.g., each suitable interaction counting as a dialogue point); and each dialogue point may have a multiplier: a so-called ‘like’ or indication of respective user approval (e.g., having a multiplier of 1×), a comment provided by the respective user (e.g., having a multiplier of 2×), a recommendation provided by the respective user (e.g., having a multiplier of 3×), or a video commentary or feedback (e.g., whether it be positive or negative feedback, having a multiplier of 4×). Thus, the dialogue input AI_{DIALOGUE} may be the sum or average of the dialogue points, each multiplied by their respective multiplier.

Expertise input AI_{EXPERTISE} can be based on rating data (which may be comprised of criteria, as described more below). Each criterion that is provided by a user that is common with or similar to a criterion provided by another user may be counted as an expertise point, and each expertise point also may have an expertise-level multiplier. For example, if the user (who provided the criterion) is considered to have a relatively low expertise level (e.g., an experimentalist level), the multiplier may be 1×. If the user is considered to have a relatively higher level (e.g., an enjoyist level), the multiplier may be 2×. If the user is considered to have a yet relatively higher level (e.g., an enthusiast level), the multiplier may be 3×. And if the user is considered to have a relatively highest level (e.g., an expert level), the multiplier may be 4×. The expertise levels may be stored in memory 42 or databases 44, and may have been previously determined by the computer 14. The four levels described above are merely examples; other levels and/or multipliers could be used instead. Thus, the expertise input AI_{EXPERTISE} may be the sum or average of the expertise points, each multiplied by their respective multiplier.

With respect to content input AI_{CONTENT} used to calculate the affinity score A, content input can include the user viewing media content (e.g., a media unit) that is common with that viewed by another user. Thus, for example, each commonly viewed media unit may be a content point and may have an associated multiplier. If for example, both users (in the pair) provided identical explicit input (AI_{EXPLICIT}), the multiplier may be 10×. For example, if the explicit input AI_{EXPLICIT} was provided on a scale of 1-10, then in this instance, |rating1−rating2|=0, and thus the multiplier could be 10×. Similarly, if their explicit ratings had a difference of “1” (e.g., |rating1−rating2|=1), then the multiplier could be 9×; and if their explicit ratings had a difference of “2” (e.g., |rating1−rating2|=2), then the multiplier could be 8×; etc.

And a location input AI_{LOCATION} can be based on a proximity between the respective users. This may be determined by computer 14 with or without user interaction. For example, a location point may be determined when the users are in the same country, and the location point may have a multiplier. For example, when the respective users are located only in the same country, the multiplier may be 1×; when the respective users are located in the same state, the multiplier may be 2×; when the respective users are located in the same city, the multiplier may be 3x; and when the respective users are located in the same neighborhood or local community (e.g., within a predetermined distance from one another (e.g., 2 miles)), then the multiplier may be 4×.

Once the explicit, dialogue, expertise, content, and location inputs AI_{EXPLICIT}, AI_{DIALOGUE}, AI_{EXPERTISE}, AI_{CONTENT}, AI_{LOCATION} are determined, they may be used by computer 14 to determine the affinity score A for the two particular users using the equation above. This process may be repeated for any suitable quantity of user pairs.

In step 215, computer 14 acts as a media content provider makes available and/or streams the particular media unit (e.g., movie MID₆₆) to a user community and at least some of the users (e.g., SID₂-SID₆) view one of the media units (e.g., MID₆₆—e.g., a movie) that user U (e.g., SID₁) has not viewed. Of course, in this example, the quantity of users (e.g., five) viewing the media unit and the type of media unit (e.g., a movie) are merely one example; this is not intended to be limiting. In the example, users SID₂-SID₆ each may be located in different residences, businesses, etc. Users SID₂-SID₆ may know one another or may not. Users SID₂-SID₆ may or may not have communicated via a social networking website or social media software application operated by computer 14 or another computer linked to computer 14 (e.g., both computers being owned by a common entity). Regardless, when users SID₂-SID₆ view media unit MID₆₆, the computer 14 may update the viewing statuses VS of users SID₂-SID₆ (e.g., changing each of VS_{2,66}, VS_{3,66}, VS_{4,66}, VS_{5,66}, and VS_{2,66} from a ‘0’ or a ‘not viewed’ status to a ‘1’ or ‘viewed’ status). Continuing with the example, as user U/SID₁ has not viewed media unit MID₆₆, the viewing status associated with user U/SID₁ in the data array DA may remain ‘0’ or ‘not viewed.’

In step 220, users SID₂-SID₆ view who have viewed media unit MID₆₆ may be given an opportunity to rate the content of media unit MID₆₆ by providing feedback or rating data in the form of qualitative and/or quantitative data associated with any suitable aspects of the media unit. For example, the qualitative and/or quantitative data may pertain to a story or plot of the media unit, the directing thereof, the acting therein, the special effects therein (if any), the historical accuracy (if applicable), the storyline plausibility (if applicable), a graphic or explicit nature of the media content (if applicable), etc.). These are merely examples; other suitable aspects also exist.

In at least one implementation, the computer 14 provides a prompt or query via the televisions of each of the users SID₂-SID₆ requesting that they provide a recorded video or video clip review—e.g., providing a visible and/or audible prompt at or near a conclusion of the content of media unit MID₆₆ (e.g., within a predetermined number of seconds of the media unit credits—e.g., a conclusion could extend 5-10 seconds before the credits appear and continue through an end of the media unit's content—the end of media unit MID₆₆'s file). The feedback prompt may be selectable. For example, the respective user may use any suitable input device (e.g., a remote control, a keyboard, a touch screen on the television, etc.) to select or accept the opportunity to provide feedback regarding the media unit (e.g., MID₆₆). The rating data may be sent to computer 14 via media device 26 and communication system 16. In at least one implementation, the computer 12 may determine whether a respective camera is configured and operable before providing the feedback prompt. For illustration's sake (and continuing with the example above), each of the users SID₂-SID₆ may record a video file discussing what they liked, what they did not like, etc. regarding media unit MID₆₆. In addition, the prompt may advise the user that their voice, image, and surroundings will be recorded and may offer legal disclaimers regarding who owns the rights to the video recording, how it may be used, etc. Further, the prompt information may advise the users SID₂-SID₆ that the video recordings will have a predetermined length (e.g., 60 seconds, 120 seconds, etc.).

It should be appreciated that receiving this feedback from the users SID₂-SID₆ may occur shortly or immediately after the users view the media unit MID₆₆. In this manner, the strongest opinions, emotions, and feelings of the respective users SID₂-SID₆ may be recorded—e.g., while the viewing experience is prevalent and recent within their minds.

In step 225, which may follow step 220, computer 14 may determine (with respect to the media unit MID₆₆) calculated scores (CS_{2,66}-CS_{6,66}) for users SID₂-SID₆. Method 400 illustrates at least a portion of step 220. As the method 400 of calculating each of scores CS_{2,66}-CS_{6,66} may be identical, the calculation of only one score (CS_{2,66}) will be described.

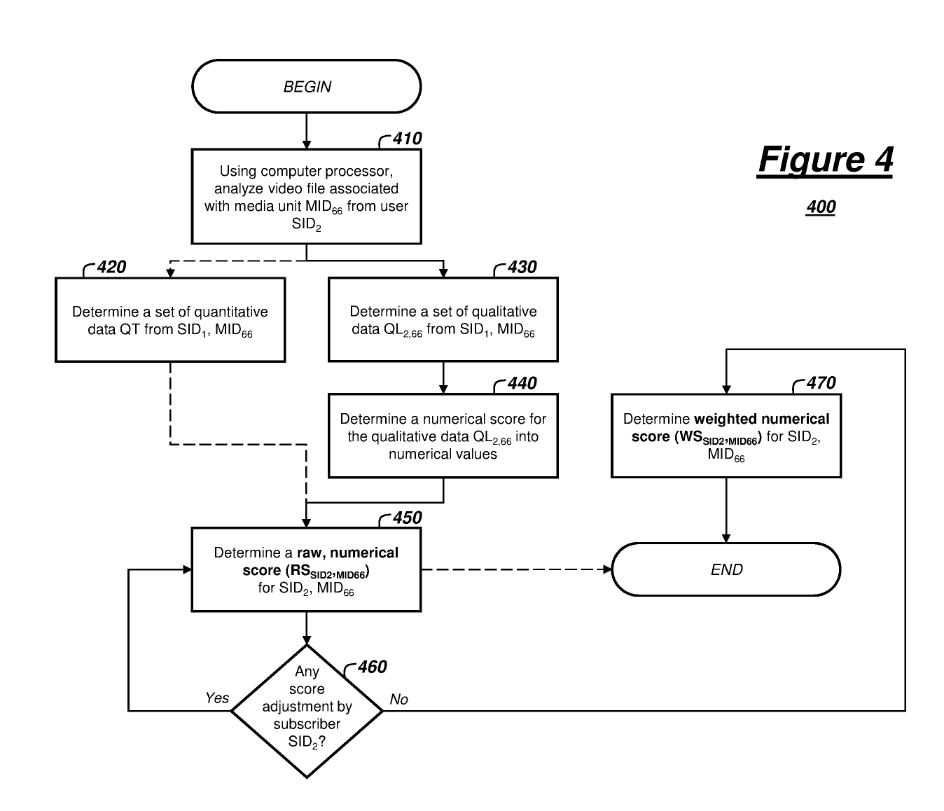

Turning now to FIG. 4, method 400 begins with step 410 wherein computer 14 (e.g., processor 40) analyzes the video file associated with user SID₂ and media unit MID₆₆. In step 410, computer 14 may extract qualitative and/or quantitative data from the video file. For example, using one or more of the automatic speech recognition algorithm, the automatic vocal inflection recognition algorithm, the vocal pattern recognition algorithm, the automatic facial recognition algorithm, the automatic gesture recognition algorithm, and other suitable algorithm available to processor 40, processor 40 may extract one or more key words, key phrases, vocal inflections, vocal patterns (e.g., frequencies and/or intensities), facial features, body gestures, and the like to determine what the user SID₂ liked or disliked about the media unit MID₆₆. Among other things, computer 14 may analyze one or more audio and/or video streams, parse audio and/or video data (e.g., including parsing all or portions of MPEG files), compress/decompress audio and/or video data, analyze sequences of digital images and/or digital speech, identify and/or classify body and facial features, and the like.

In step 420, which follows step 410, if the computer 14 determines that user SID₂ provided any quantifiable or quantitative data, the processor 40 may store this type of rating data as a set of quantitative data (QT_{2,66}) in memory 42, databases 44, or both. The quantitative data may include one or more criteria such as user SID₂ stating ‘4-out-of-5 stars,’ ‘that movie was a 10,’ etc. As used herein, a criterion includes a word, a phrase or sentence, a facial expression, a bodily gesture, or the like—thus, a quantitative criterion indicates, includes, or states a numerical value. Thus, stating ‘4-out-of-5 stars’ may be one criterion, a facial expression which accompanies that phrase may be another (concurrently occurring) criterion, and a body gesture which accompanies that phrase and/or the facial expression may be yet another (concurrently occurring) criterion. The processor 40 may assign a numerical value to each quantitative criterion, to the quantitative data as a whole, or combination thereof (and the assigned values may be inherent). For example, the quantitative criterion ‘4-out-of-5-stars’ may be assigned a numerical value of ‘4,’ and the quantitative criterion ‘that movie was a 10’ may be assigned a numerical value of ‘10.’ And in some instances, it may be desirable to normalize the processed quantitative data (e.g., normalizing a ‘4-out-of-5 stars’ to an ‘8’ if a 10-point scale is being used by computer 14). Of course, feedback for a single media unit (e.g., MID₆₆) may comprise multiple quantitative criteria. Further, in some implementations, the user SID₂ may manually enter one or more quantitative criteria and upon receipt, computer 14 may store it with the set of quantitative data—e.g., manually enter an actual number (e.g., type a ‘10’ into a keyboard (not shown) connected to the media device 26), enter a selection (e.g., via a remote control (not shown)) representing a numerical value or score, or the like. The set of processed quantitative data can include zero criteria, a single criterion, or multiple criteria.

In step 430, which follows also step 410, if the computer 14 determines that user SID₂ provided any raw or unprocessed qualitative data, then processor 40 may store this type of rating data as a set of raw qualitative data (QL_{2,66}) in memory 42, databases 44, or bot. Raw qualitative data comprises one or more qualitative criteria—e.g., wherein a qualitative criterion includes a word, a phrase or sentence, a facial expression, a bodily gesture, a vocal inflection, a vocal pattern, or the like that pertains to a non-numeric quality, value, or measure. Thus, non-limiting examples of qualitative criteria include key words or phrases such as ‘awesome,’ ‘outstanding performance by a lead actor,’ ‘I could watch that over and over again,’ ‘worst movie ever,’ ‘a candidate for the Rotten Tomatoes Award’ and user facial expressions, gestures, vocal inflections and patterns such as a wink, a nod, a wide-eyed look, a mouth agape, a smile, a frown, a manner of speaking, a change in words-per-minute or speech tempo, a speech speed, a rising or falling vocal pitch, etc. Feedback for a single media unit (e.g., MID₆₆) may comprise multiple qualitative criteria. And the set of raw qualitative data also can include zero criteria, a single criterion, or multiple criteria. It should be appreciated that steps 420 and 430 may occur sequentially and/or concurrently.

In step 440, the processor 40 may determine numerical values for the individual qualitative criterion of set QL_{2,66}, for the entire set of qualitative data QL_{2,66}, or some combination thereof. For example, the qualitative criteria or data now may be assigned one or more numerical values, whereas previously, the raw qualitative criteria or data included non-numerical information, as discussed above.

To illustrate an example: processor 40 can compare the set of raw qualitative data QL_{2,66} with previously-scored user-provided rating data (e.g., which qualitative in nature and which was previously assigned one or more numerical values—being stored, e.g., in memory 42) and determine a numerical value or score for the present set of qualitative data QL_{2,66}. In some instances, this may require summing values (or sub-scores) for a number of qualitative criteria to determine a total numerical score. With respect to converting the raw qualitative data or criteria into numerical value(s): some extracted qualitative word(s) or phrases may be scored higher or lower depending on whether they are coupled with certain vocal inflection(s) data, certain vocal pattern data, certain facial recognition data, and/or certain gesture recognition data. One example is illustrated in the equation below. In addition, the raw qualitative data QL_{2,66} (for user SID₂, movie MID₆₆) may be processed by a neural network algorithm also stored in memory 42 and executable by processor 40. In this manner, computer 14 may learn new words, phrases, and their associated meanings; and these learned words, phrases, vocal inflections, vocal patterns, facial features, gestures, etc. may be stored in memory 42, database 44, or both along with qualitative value(s) for future determinations of sets of qualitative data, conversions to numerical scores, etc.

In step 450, the values derived from the processed qualitative data QL_{2,66} and the processed quantitative data QT_{2,66} may be combined to determine a raw numerical score RS_{SID2,MID66}. For example, in one implementation, all processed qualitative and quantitative criteria values may be added together and averaged. In another example, only processed qualitative criteria values from set QL_{2,66} are used to determine the raw numerical score RS_{SID2,MID66}. For example, this may be desirable when the user SID₂ does not provide quantitative data during the short video clip, or when the computer 14 determines that the quantitative data should be ignored as unreliable. In another example, both processed quantitative and qualitative values are used; however, the qualitative values are given a higher weighting than the quantitative values. These are merely examples; others exist.

It should be appreciated that the computer 14 may determine the raw numerical score RS_{SID2,MID66} using any suitable mathematical compilation; e.g., averaging is merely one technique. The computer 14 may perform step 450 using any suitable combination of mean calculations, median calculations, mode calculations, normalization calculations, etc.

As described above, calculating the raw, numerical score (RS_{SID2,MID66}) in step 450 may be based on both the processed qualitative data QL_{2,66} and the processed quantitative data QT_{2,66}. In one non-limiting example, this calculation includes the following equation: the raw numerical score (RS_{SID2,MID66})=[an explicit input (RI_{EXPLICIT})*an explicit priority value (RP_{EXPLICIT})+a keyword input (RI_{KEYWORD})*a keyword priority value (RP_{KEYWORD})+a vocal input (RI_{VOCAL})*a vocal priority value (RP_{VOCAL})+a facial input RI_{FACIAL})*a facial priority value (RP_{FACIAL})+a body input (RI_{BODY})*a body priority value (RP_{BODY})]/(RP_{EXPLICIT}+RP_{KEYWORD}+RP_{VOCAL}+RP_{FACIAL}+RP_{BODY}).

Similarly, when determining the raw, numerical score RS_{SID2,MID66} without using quantitative data QT_{2,66}, then the following example equation may be used: RS_{SID2,MID66}=[RI_{KEYWORD}*RP_{KEYWORD}+RI_{VOCAL}*RP_{VOCAL}+RI_{FACIAL}*RP_{FACIAL}+RI_{BODY}*RP_{BODY}]/(RP_{KEYWORD}+RP_{VOCAL}+RP_{FACIAL}+RP_{BODY}). Note here, the explicit input RI_{EXPLICIT} and the explicit priority value RP_{EXPLICIT} have been removed from the equation above.

Non-limiting examples of priority values can include: RP_{EXPLICIT}=5, RP_{KEYWORD}=4, RP_{VOCAL}=3, RP_{FACIAL}=2, and RP_{BODY}=1. Other examples also exist, including example equations having more or fewer inputs and/or more or fewer priority values. The priority values used in the equation above may be predetermined values and may be stored in memory 42 and/or databases 44.

With respect to the explicit input RI_{EXPLICIT}, when used, this input may be a value manually entered by the user (e.g., SID₂) via media device 26 indicating his/her approval of the media unit MID₆₆ (e.g., as a whole, or with respect to some aspect of the media unit). In at least one example, this input includes a numeral within a range of 1 to 10.

With respect to the keyword input RI_{KEYWORD}, each qualitative word and/or phrase criterion can be assigned by computer 14 a numerical value in the range of 1 to 10. These numerical values can be averaged to determine the keyword input RI_{KEYWORD} value.

With respect to the vocal input RI_{VOCAL}, each vocal feature criterion (e.g., including volume, inflection, pitch, etc.) can be assigned by computer 14 a numerical value in the range of 1 to 10. Similarly, these numerical values can be averaged to determine the vocal input RI_{VOCAL} value.

With respect to the facial input RI_{FACIAL}, each facial feature criterion (e.g., including smiles, frowns, eyebrow position/changes, etc.) are assigned by computer 14 a numerical value in the range of 1 to 10. Similarly, these numerical values can be averaged to determine the facial input RI_{FACIAL} value.

And with respect to the body input RI_{BODY}, each body feature criterion (e.g., including folded arms, hand waves, pointing, etc.) are assigned by computer 14 a numerical value in the range of 1 to 10. Similarly, these numerical values can be averaged to determine the body input RI_{BODY} value.

Once the explicit, keyword, vocal, facial, and/or body inputs RP_{EXPLICIT}, RP_{KEYWORD}, RP_{VOCAL}, RP_{FACIAL}, RP_{BODY} are determined, they may be used by computer 14 to determine the raw, numerical score RS_{SID2,MID66}, using one of the two equations above. Following step 450, the process 400 may proceed to step 460.

Step 460 is optional. Here, the computer 14 may present the calculated raw numerical score RS_{SID2,MID66} to the user SID₂ (e.g., transmitting it via the communication system 16 and displaying it on the user's respective television). In response, computer 14 may receive and accept input from SID₂ (e.g., via media device 26 and communication system 16). For example, this may permit the user SID₂ to adjust the score RS_{SID2,MID66} or provide additional feedback that may be used by computer 14 to adjust the score RS_{SID2,MID66}. If the user SID₂ provides adjustment data, then the computer 14 repeats step 450 using the provided adjustment data (e.g., looping back and repeating step 450). However, if no adjustment data is provided (or if step 450 is omitted by computer 14), the method 400 proceeds to step 470.

In step 470, the computer 14 optionally may determine a weighted numerical score WS_{SID2,MID66}. In at least one example, the weighted numerical score WS_{SID2,MID66} is the same as the calculated score determined in step 220 (FIG. 2). In other examples, the calculated score is the raw numerical score RS_{SID2,MID66} (step 450) or some other calculated score. In step 470, the computer 14 calculates the weighted score WS_{SID2,MID66} by using additional factors to further refine the raw score RS_{SID2,MID66}. For example, the entire raw score RS_{SID2,MID66} may be multiplied by a weighting factor to determine the weighted score WS_{SID2,MID66}; or individual criteria of the set of qualitative data QL_{2,66} (e.g., individual criterion scores) may be multiplied by one or more weighting factors to ultimately determine the weighted score WS_{SID2,MID66}. Factors used to determine the weighted score WS_{SID2,MID66} are discussed below.

Non-limiting examples of weighting factors that may increase the weight of the raw score or criteria thereof include: that the user SID₂ watches (or typically highly rates) media units within a common media type or genre (i.e., user SID₂ is knowledge-able with respect to the genre); that within the video clip the user SID₂ uses a predetermined quantity (or a proportional quantity) of positive qualitative criteria (e.g., says ‘awesome’ or synonyms of ‘awesome’ at least several times); that the user SID₂ has a high credibility rating over all media genres (e.g., based on the opinions of other users—e.g., SID1, SID3, SID4, . . . ); that the user SID₂ has a high credibility rating within the genre to which MID₆₆ belongs (e.g., based on the opinions of other users—e.g., SID₁, SID₃, SID₄, . . . ); that the raw score RS_{SID2,MID66} is consistent with the entire community of users (e.g., SID₁, SID₃, SID₄, . . . , SID_{N}) (e.g., a difference between raw score and a community score is less than a predetermined threshold); that the raw score RS_{SID2,MID66} is consistent with a subset of the community of users (e.g., SID₁, SID₃, SID₄, SID₅, and SID₆)—e.g., those users who have viewed the media unit MID₆₆ (e.g., a difference between raw score and a subset of the community score is less than a predetermined threshold); that qualitative criteria from other users or individuals—e.g., who were also recorded within the same video clip as user SID₂—are consistent with the raw score RS_{SID2,MID66}; that the raw score RS_{SID2,MID66} is consistent with any social media published by user SID₂; that any online publications (other social media commentary) by user SID₂ which are published using a media content provider (e.g., such as computer 14) are also consistent with the raw score RS_{SID2,MID66} (e.g., via a media content provider platform enabling chat, text, etc.). Of course, these are merely examples of criteria which could be used by computer 14 to change a multiplier (e.g., of ‘1’) to a higher value (e.g., ‘1.1,’ ‘1.2,’ . . . )—thereby changing (or weighting) the raw score RS_{SID2,MID66} to a higher value.

Non-limiting examples of weighting factors that may decrease the weight of the raw score or criteria thereof include: that the user SID₂ dilutes his/her qualitative data by over-using one or more qualitative criteria (e.g., uses the same criteria more than a predetermined number of times within the same video clip; or e.g., uses the same criteria more than a predetermined number of times within two or more video clips—e.g., accounting for the user's past created video clips); that the raw score RS_{SID2,MID66} is inconsistent with a community of users (e.g., SID₁, SID₃, SID₄, . . . , SID_{N}) (e.g., a difference between raw score and a community score is greater than or equal to a predetermined threshold); that the raw score RS_{SID2,MID66} is inconsistent with a subset of the community of users (e.g., SID₁, SID₃, SID₄, SID_{S}, and SID₆)—e.g., those users who have viewed the media unit MID₆₆ (e.g., a difference between raw score and a subset of the community score is greater than or equal to a predetermined threshold); that qualitative criteria from other users or individuals—e.g., who were also recorded within the same video clip as user SID₂—are inconsistent with the raw score RS_{SID2,MID66}; that the raw score RS_{SID2,MID66} is inconsistent with any social media published by user SID₂; that any online publications (other social media commentary) by user SID₂ which are associated with the media content provider are also inconsistent with the raw score RS_{SID2,MID66} (e.g., via a media content provider platform enabling chat, text, etc.). Of course, these are merely examples of criteria which could be used by computer 14 to change a multiplier (e.g., of ‘1’) to a lower value (e.g., ‘0.9,’ ‘0.8,’ . . . )—thereby changing (or weighting) the raw score RS_{SID2,MID66} to a lower value.

According to at least one example, step 470 includes two sub-steps: first calculating a weight W_{SID2,MID66}—associated with the raw, numerical score RS_{SID2,MID66}; and then determining the weighted numerical score WS_{SID2,MID66} using the calculated weight W_{SID2,MID66} Each example sub-step will be discussed in turn.

In the first non-limiting sub-step example, the weight W_{SID2,MID66} calculation includes the following equation: weight W_{SID2,MID66}=[a dialogue input (WI_{DIALOGUE})*a dialogue priority value (WP_{DIALOGUE})+an expertise input (WI_{EXPERTISE})*an expertise priority value (WP_{EXPERTISE})+a history input (WI_{HISTORY})*a history priority value (WP_{HISTORY})+a keyword input (WI_{KEYWORD})*a keyword priority value (WP_{KEYWORD})+an average input (WI_{AVERAGE})*an average priority value (WP_{AVERAGE})]/(10*(WP_{DIALOGUE}+WP_{EXPERTISE}+WP_{HISTORY}+WP_{KEYWORD}+WP_{AVERAGE})).

According to one non-limiting example, WP_{DIALOGUE}, WP_{EXPERTISE}, WP_{HISTORY}, WP_{KEYWORD}, WP_{AVERAGE}, priority values may be 5, 4, 3, 2, 1, respectively. Other examples also exist, including an example equation having more or fewer inputs and/or more or fewer priority values. The priority values used in the weight W_{SID2,MID66} calculation may be predetermined values and may be stored in memory 42 and/or databases 44.

With respect to the dialogue input, dialogue input WI_{DIALOGUE} can be based upon user-interaction associated with the media content itself (e.g., MID₆₆) via media device 26. Each interaction may count as a dialogue point, and each dialogue point may include a multiplier: a so-called ‘like’ or indication of respective user approval (e.g., having a multiplier of 1×), a comment provided by the respective user (e.g., having a multiplier of 2×), a recommendation provided by the respective user (e.g., having a multiplier of 3×), or a video commentary or feedback (e.g., whether it be positive or negative feedback, having a multiplier of 4×). Thus, the dialogue input WI_{DIALOGUE} may be the sum or average of the dialogue points, each input being multiplied by its respective multiplier.

With respect to the expertise input WI_{EXPERTISE}, this input can be based on rating data (which may be comprised of qualitative and/or quantitative criteria). Each criterion that is provided by a user that is common with or similar to a criterion provided by another user (who has also viewed the particular media unit M₆₆) may be counted as an expertise point, and each expertise point may have an expertise-level multiplier. For example, if the user (who provided the criterion) is considered to have a relatively low expertise level (e.g., an experimentalist level), the multiplier may be 1×. If the user is considered to have a relatively higher level (e.g., an enjoyist level), the multiplier may be 2×. If the user is considered to have a yet relatively higher level (e.g., an enthusiast level), the multiplier may be 3×. And if the user is considered to have a relatively highest level (e.g., an expert level), the multiplier may be 4×. The expertise levels may be stored in memory 42 or databases 44, and may have been previously determined by the computer 14. The four levels described above are merely examples; other levels and/or multipliers could be used instead. Thus, the expertise input WI_{EXPERTISE} may be the sum of the expertise points, each multiplied by their respective multiplier. Further, in at least one example, the value of expertise input WI_{EXPERTISE} may equal the value of expertise input AI_{EXPERTISE}, discussed above.

With respect to the history input W_{IHISTORY}, computer 14 may normalize the raw, numerical score RS_{SID2,MID66} using with other raw, numerical scores RS_{SID2,MIDM} (e.g., which were based on user SID₂'s scores of at least some other media units). And this normalized value may be assigned as the history input WI_{HISTORY}. In this manner, an abnormal distribution of scores (e.g., including RS_{SID2,MID66} and RS_{SID2,MIDM}) will affect the weight W_{SID2,MID66}, whereas, a normal distribution will not.

With respect to the keyword input WI_{KEYWORD}, computer 14 may normalize a qualitative word or phrase (e.g., “awesome”) used by user SID₂ with respect to media unit M₆₆ using previous uses of the same qualitative word or phrase by user SID₂ (e.g., after watching different media units). This normalized value may be assigned as the keyword input WI_{KEYWORD}. In this manner, an abnormal distribution of scores will affect the weight W_{SID2,MID66}, whereas, a normal distribution will not. For example, if a qualitative word such as “awesome” is repetitively used (e.g., a dozen times per minute), this qualitative criterion will be given less weight.

With respect to the average input WI_{AVERAGE}, the average input WI_{AVERAGE} may be determined by computer 14 based on its relative closeness to an average rating by the user community (e.g., a subset of all users SID_{N}) who have viewed the media unit MID₆₆. For example, if the score RS_{SID2,MID66} is less than 1 threshold point of the user community subset, the average input WI_{AVERAGE} will be higher than if the score RS_{SID2,MID66} is between 1 and 2 threshold points of the user community subset. Thus, the average input WI_{AVERAGE} may be a value between 1 and 10.

Once the weight W_{SD2,MID66} is determined, the weighted numerical score WS_{SID2,MID66} may be determined using the second non-limiting sub-step example calculation: WS_{SID2,MID66}=Σ[RS_{SID2,MID66}*((weight W_{SID2,MID66})/Σ(weight W_{SIDsubset,MID66}))], wherein weight W_{SIDsubset,MID66} is the sum of all the weight numerical scores of those users who have both viewed the media unit MID₆₆ and for whom also have a minimum threshold affinity score with respect to user SID₂ (e.g., greater than or equal to 0.7, according to one non-limiting example). Thus, in at least one example, the weighted numerical score WS_{SID2,MID66} will be a numerical value between 1 and 10.

Thus, in step 470, the computer 14 determines the weighted numerical score WS_{SID2,MID66} and returns it to method 200. For example, in one example, computer 14 applies one or more multipliers to the raw score RS_{SID2,MID66} to determine the weighted score WS_{SID2,MID66}. Thus following step 470, the method 400 ends, and thereafter method 200 continues with step 225.

In step 230 (FIG. 2), the affinity scores may be updated again using a procedure similar to that described above in step 210. Continuing with the example, the affinity scores (A_{2,66}-A_{6,66}) of users SID₂-SID₆ are updated since these five users have now viewed media unit MID₆₆.

In step 235, the computer 14 determines a predicted score PS_{SID1,MID66} for user SID₁ based on the affinities updated in step 230 and the respective calculated scores of users SID₂-SID₆ (e.g., those users who have seen the movie MID₆₆) from step 225. According to one example, only users having a threshold affinity score are used in the prediction (e.g., having an affinity score greater than 0.7 on a scale of 0 to 1.0, wherein ‘0’ is the lowest affinity score and ‘1.0’ is the highest affinity score; of course, the threshold 0.7 is merely an example and any suitable value may be used). For illustrative purposes, users SID₂-SID₆ shall be considered in this example to each have calculated scores (CS) higher than the threshold; thus, each may be used in the prediction. Next, the calculated scores of users SID₂-SID₆ may be each multiplied by their respective affinity scores (e.g., A_{2,66}-A_{6,66}) and averaged to determine a predicted score. For example, the predicted score for user U/SID₁ may be expressed as: PS_{SID1,MID66}=(WS_{SID2,MID66}*A_{2,66}+WS_{SID3,MID66}*A_{3,66}+WS_{SID4,MID66}*A_{4,66}+WS_{SID5,MID66}*A_{5,66}+WS_{SID6,MID66}*A_{6,66})/5. Thus, if the weighted scores (WS) were between 0 and 10 (e.g., for users SID₂-SID₆ respectively: 4, 5, 6, 7, and 8) and if the affinities for users SID₂-SID₆ respectively were: 0.7, 0.7, 0.8, 0.9, 1.0, then using this calculation, the predicted score will be ‘5.08.’ This is merely one example however with respect to calculating a predicted score; other methods and techniques are possible.

In another example of determining the predicted score PS_{SID1,MID66}, the computer 14 may use the following non-limiting calculation: the predicted score PS_{SID1,MID66} for SID₁=Σ (RS_{SID(n),MID66}*((A_{1,n}+W_{SID(n),MID66})/(Σ(A_{1,n}+W_{SIDsubset,MID66})), for a quantity of n users who have viewed the particular media unit. Thus, the predicted score PS_{SID1,MID66} may be a numerical value in the range of 1 to 10. And according to at least one application, the predicted score PS_{SID1,MID66} also may be used to present computer 14 suggested media units (in order of highest to lowest predicted score) to the respective user (e.g., SID₁).

In some instances (once calculated), the predicted score PS_{SID1,MID66} is provided by the computer 14 to the user U/SID₁—e.g., displayed via television 20 or by any other suitable means (e.g., internet web portal, text message, email notification, mobile device software application, etc.). In one example, the predicted score PS_{SID1,MID66} is provided to user U/SID₁ prior to the user viewing the movie MID₆₆; in another example, the predicted score PS_{SID1,MID66} is provided to user U/SID₁ after the user views movie MID₆₆. In other instances, it is not provided at all.

Regardless of whether the predicted score is disclosed to the user U/SID₁ (and/or the manner in which it is disclosed, if at all), in step 240, user U/SID₁ views the media unit. For example, computer 14 acts as a media content provider and makes available movie MID₆₆ for viewing by user U/SID₁. For example, using media device 26, user U/SID₁ may select and view the movie MID₆₆ on television 20 (e.g., provided by or streaming ultimately from computer 14). And as a result, computer 14 changes the viewing status of user U/SID₁—e.g., changing VS_{1,66}, from a ‘0’ or a ‘not viewed’ status to a ‘1’ or ‘viewed’ status.

Following step 240, in step 245, computer 14 invites user U/SID₁ to provide feedback or rating data (e.g., to create a video file or video clip using camera 22—similar to the video clips which were created by users SID₂-SID₆, discussed above (step 220)). In at least one example, user U/SID₁ creates a video clip of similar duration and in an identical manner; thus, this process will not be described again. It is expected that the quantitative and/or qualitative data provided by user U/SID₁ will be his/her own thoughts and opinions.

In step 250, using the created video file of user U/SID₁, the computer 14 automatically determines an actual or calculated score (CS) in a manner similar to that described above with respect to step 225 (and method 400). Thus, this process will not be re-explained here. Again, this calculated score (CS) may comprise the computer-generated raw score, the computer-generated weighted score, or any other computer-generated score. In at least one example, the actual or calculated score is a weighted score WS_{SID1,MID66} of user U/SID₁.

In step 255, the calculated score of user U/SID₁ (e.g., WS_{SID1,MID66}) is stored in database 44. For example, this calculated score may be stored along with other calculated scores of user U/SID₁, as well as other calculated scores of users within the user community (e.g., calculated scores of media units MID₁-MID_{M}).

Following step 255, in step 260, computer 14 may determine whether the calculated score (WS_{SiD1,MID66}) of user U/SID₁ differs significantly from the predicted score (PS_{SID1,MID66}) of user U/SID₁. In at least one example, computer 14 determines a difference between user U/SID₁'s calculated score and the predicted score (e.g., |WS_{SID1,MID66}−PS_{SID1,MID66}|), and when the difference is greater than a predetermined threshold, the computer 14 initiates a digital dialogue between user U/SID₁ and at least one other user (e.g., as explained below in step 265). And when the difference (e.g., |WS_{SID1,MID66}−PS_{SID1,MID66}|) equals or does not exceed the predetermined threshold, then method 200 ends.

In step 265, the computer 14 initiates or prompts a digital dialogue between user U/SID1 and at least one user who has also seen the movie MID₆₆ in order to stimulate conversation between users—e.g., to encourage, inspire, rouse, etc. conversation regarding the computer-detected disparity. The computer 14 triggers the digital dialogue according to a realization that the computer-detected disparity or variance (i.e., that the difference in step 260 was larger than the predetermined threshold) is an indicator of something worthy of human conversation, and that by initiating the digital dialogue, the conversation will be desirable to one or more users. As used herein, prompting or initiating a digital dialogue includes the computer 14 establishing any suitable communication connection between user U/SID₁ and another user for the purpose of discussing media unit MID₆₆ (e.g., a wired communication connection, a wireless communication connection, or a combination of both wired and wireless communication connections). Non-limiting examples of a digital dialogue include: a live text chat session (e.g., a private messaging window, a chat room, etc.), a live audio chat session, a live video chat session, any social media or person-to-person online engagement, group text or SMS messaging, etc. Thus, the chat dialogue may be viewed on the respective users' televisions, mobile devices (e.g., Smartphones, electronic notepads, personal computers, etc.), or any other suitable electronic device.

According to at least one implementation of step 265, computer 14 determines or identifies an aspect or element of the prediction calculation (e.g., shown in methods 200, 400) that led to the disparity or variance. For example, the computer 14 may parse the criteria (and values) which formed the input to its prediction (e.g., in step 235) and determine that the calculated score (or one or more criteria which formed a respective calculated score) from at least one of the users SID₂-SID₆ caused the disparity or variance in the predicted score. For example, assume users SID₁ and SID₆ have a high affinity score (e.g., continuing with the example, affinity score A_{1,6}=‘1.0’). With respect to movie MID₆₆, if the calculated score of user SID₆ was relatively high (e.g., CS_{6,66}=‘8’) (e.g., because, based on the qualitative data, user SID₆ thought the action and special effects were outstanding) and if the calculated score of user SID₁ was relatively low (e.g., CS_{1,66}=‘4’) (e.g., because, based on the qualitative data, user SID₁ thought the performance by the lead actor was terrible), then computer 14 may identify this as at least one root cause leading to the disparity. In step 265, computer 14 may present this root cause within the chat room (e.g., as it initiates the digital dialogue). For example, the computer-generated dialogue may be: “User [SID₁]: You and User[SID₆] historically would rate this movie the same; however, you did not. User[SID₆] thought the action and special effects in this movie were outstanding. Why did you rate this movie lower'?” Or the computer-generated dialogue could include: “What was it about the lead actor's performance that caused the lower rating?” Or the conversation starter might be: “Did you like the action and special effects'?” Thus, in an example, a digital dialogue may be initiated between a former viewer of the movie MID₆₆ (e.g., SID₆) and the current viewer of the movie (e.g., SID₁)—and that the former viewer may be identified based on one or more distinctive qualitative inputs (e.g., detected key words indicative of qualitative data, detected key phrases indicative of qualitative data, detected vocal inflections, detected vocal patterns indicative of qualitative data, detected facial expressions indicative of qualitative data, detected bodily gestures indicative of qualitative data, etc.).

In optional step 270, computer 14 may improve its affinity scoring ability and/or its predictive scoring capability by extracting additional rating data (e.g., additional quantitative and/or qualitative data (or quantitative and/or qualitative criteria)) from the digital dialogue. It has been realized that the conversation and dialogue which results from identifying a root cause of a predictive mismatch is rich in qualitative data. Thus in step 270, computer 14 automatically may acquire additional qualitative data (QL_{1,66}, QL_{6,66}) (and/or additional quantitative data (QT_{1,66}, QT_{6,66})) regarding movie MID₆₆ using the techniques discussed above (e.g., in step 225). And this additional qualitative and quantitative data may be stored in data array DA for the respective dialogue participants (e.g., for users SID₁ and SID₆). And any extracted data may be used by computer 14 in future predictive scoring (e.g., such as step 225). And consequently, the extracted data may improve affinity scoring between user U/SID₁ (or user SID₆) and the remainder of the user community. Following step 265 and/or (optional step 270), the method 200 may end.

The subject matter set forth herein enable users of an interactive media system to generate conversation about the content of media units such as television shows, movies, and the like. In this manner, the users may learn from one another—e.g., rather than only professional media content critics. The interactive media system includes one or more computers adapted to provide media content to a user community, receive feedback from at least some of the users regarding the content of a media unit, predict a rating by a later user who has not viewed the media unit (e.g., at least some aspects of what the later user will think once he/she views it), receive feedback from the later user, use the later user's feedback to determine an actual rating by the later user, and then based on a difference between the actual and predicted ratings (that is larger than a threshold), initiate conversation about the media unit between the later user and at least one other user.

In general, the computing systems and/or devices described may employ any of a number of computer operating systems, including, but by no means limited to, versions and/or varieties of the Microsoft® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, or the Android operating system developed by Google, Inc. and the Open Handset Alliance. Examples of computing devices include, without limitation, a computer server, a computer workstation, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer, comprising a processor and memory, the memory storing instructions executable by the processor such that the processor is programmed to:
predict a first score for a first user who has not viewed a media unit based on at least an affinity score between the first user and a second user and rating data provided by the second user that is associated with the media unit;
after the first user has viewed the media unit, determine a second score for the first user based on rating data provided by the first user that is associated with the media unit; and
upon determining that a difference between the first score and the second score is greater than a threshold, initiate a digital dialogue between the first and second users.

2. The computer of claim 1, wherein the rating data provided by the first user or the second user includes at least one of qualitative data and quantitative data.

3. The computer of claim 1, wherein the rating data provided by the first user or the second user includes a set of qualitative data that includes one or more keywords, one or more key phrases, one or more facial expressions, one or more vocal inflections, one or more vocal patterns, or one or more bodily gestures.

4. The computer of claim 1, wherein the processor is further programmed to determine the affinity score between the first and second users based at least in part on a familial relationship, a friend relationship, previous digital dialogues between the users, or a physical proximity.

5. The computer of claim 1, wherein initiating the digital dialogue includes establishing a wired communication connection, a wireless communication connection, or a combination of both wired and wireless communication connections between the first and second users.

6. The computer of claim 1, wherein the processor is further programmed to extract additional rating data from the digital dialogue and use the additional rating data to improve future predicted scoring.

7. The computer of claim 1, wherein the processor is further programmed to receive a video clip from the second user and extract the rating data provided by the second user from the video clip.

8. The computer of claim 1, wherein the processor is further programmed to receive a video clip from the first user and extract the rating data provided by the first user from the video clip.

9. The computer of claim 1, wherein the processor further is programmed to determine the first score by first calculating a raw score using the rating data provided by the second user and then calculating a weighted numerical score using the raw score, wherein the processor further is programmed to determine the second score by first calculating another raw score using the rating data provided by the first user and then calculating another weighted numerical score using the another raw score.

10. The computer of claim 1, wherein the processor is configured to execute one or more of the following algorithms to determine the predicted score or to determine the actual score: an automatic speech recognition algorithm, an automatic vocal inflection recognition algorithm, an automatic vocal pattern recognition algorithm, an automatic facial recognition algorithm, or an automatic gesture recognition algorithm.

11. A method, comprising:
predicting, at a computer, a first score for a first user who has not viewed a media unit based on at least an affinity score between the first user and a second user and rating data provided by the second user that is associated with the media unit, wherein the computer comprises a processor and memory, wherein the memory stores instructions executable by the processor;
after the first user has viewed the media unit, determining a second score for the first user based on rating data provided by the first user that is associated with the media unit;
determining a difference between the first score and the second score is greater than a threshold;
in response to determining the difference is greater than a threshold, initiating a digital dialogue between the first and second users;
extracting additional rating data from the digital dialogue; and then,
using the additional rating data to determine a future score for another media unit not yet viewed by the first user.

12. The method of claim 11, wherein the rating data provided by the first user, the rating data provided by the second user, or the additional rating data includes at least one of qualitative data and quantitative data.

13. The method of claim 11, wherein the rating data provided by the first user, the rating data provided by the second user, or the additional rating data includes a set of qualitative data that includes one or more keywords, one or more key phrases, one or more facial expressions, one or more vocal inflections, one or more vocal patterns, or one or more bodily gestures.

14. The method of claim 11, further comprising determining the affinity score using the processor, wherein the affinity score between the first and second users is based at least in part on a familial relationship, a friend relationship, previous digital dialogues between the users, or a physical proximity.

15. The method of claim 11, wherein the step of initiating the digital dialogue further includes establishing a wired communication connection, a wireless communication connection, or a combination of both wired and wireless communication connections between the first and second users.

16. The method of claim 11, further comprising receiving at the processor a video clip from the second user and extracting the rating data provided by the second user from the video clip.

17. The method of claim 11, further comprising receiving a video clip from the first user and extracting the rating data provided by the first user from the video clip.

18. The method of claim 11, further comprising determining the first score by first calculating a raw score using the rating data provided by the second user and then calculating a weighted numerical score using the raw score, and further comprising determining the second score by first calculating another raw score using the rating data provided by the first user and then calculating another weighted numerical score using the another raw score.

19. The method of claim 11, wherein the processor is configured to execute one or more of the following algorithms to determine the predicted score or to determine the actual score: an automatic speech recognition algorithm, an automatic vocal inflection recognition algorithm, an automatic vocal pattern recognition algorithm, an automatic facial recognition algorithm, or an automatic gesture recognition algorithm.

20. A computer, comprising a processor and memory, the memory storing instructions executable by the processor such that the processor is programmed to:
predict a first score for a first user who has not viewed a media unit based on at least an affinity score between the first user and a second user and qualitative data provided by the second user that is associated with the media unit;
after the first user has viewed the media unit, determine a second score for the first user by extracting qualitative data from a video clip of the first user;
determine a difference between the first and second scores; and
when the difference is greater than a predetermined threshold, then initiate a digital dialogue between the first and second users.
